(19) United States
(12) Patent Application Publication
(10) Pub. No.: US 2020/0240390 A1
(43) Pub. Date: Jul. 30, 2020

(54) APPARATUS FOR GENERATING ELECTRICITY USING WATER MOVEMENT

(71) Applicant: Ocean Current Energy LLC, London (GB)

(72) Inventors: William Edward Baxley, Hollyword, FL (US); Patrick James Mulvey, San Diego, CA (US); Bruce Heafitz, Aventura, FL (US)

(21) Appl. No.: 15/768,243

(22) PCT Filed: Nov. 3, 2016
(86) PCT No.: PCT/GB2016/000195

§ 371 Date: Apr. 13, 2018

(30) Foreign Application Priority Data
Nov. 4, 2015 (GB) 1519534.0

(51) Int. Cl. F03B 17/06; F03B 13/10; F03B 15/00

(52) U.S. Cl. CPC F03B 17/06; F03B 15/00; F03B 13/10

(57) ABSTRACT

Apparatus (2) for generating electricity using water movement, which apparatus (2) comprises: (i) at least one electrical generator (4) which is for generating the electricity and which comprises a housing (6), a rotor (8) and a stator (10); (ii) at least one control means (12) for use in the maintenance of the apparatus (2), and the apparatus (2) being such that: (iii) the control means (12) is configured to enable the removal of at least a defective part (14) in the electrical generator (4); (iv) the control means (12) is configured to enable the reception of a replacement part (16) for the defective part (14); (v) the apparatus (2) includes transport means (18) for transporting the defective part (14) around the apparatus (2) such that the defective part (14) is able to be removed from the apparatus (2), and for transporting the replacement part (16) around the apparatus (2) such that the replacement part (16) is able to be installed in place of the defective part (14); and (vi) the defective part (14) and the replacement part (16) are parts whereby the defective part (14) is able to be removed by the control means (12), the replacement part (16) is able to be installed by the control means (12), and the removal and replacement are able to be effected without the need for divers even although the apparatus (2) in use is submerged at depth in the water.

This invention relates to apparatus for generating electricity and, more especially, this invention relates to apparatus for generating electricity using water movement.

Apparatus for generating electricity using water movement is known. Typically, the apparatus is installed in oceans at considerable depth. Maintenance of the apparatus soon becomes a problem. Sometimes maintenance work that may be required has to be done by divers, and then the divers are required to work in dangerous conditions. Often the apparatus is not able to be repaired using divers, in which case new apparatus is required. The cost of manufacture and installation of the apparatus is high. Also, the defective apparatus often has to be removed because it is environmentally unacceptable to leave it in position, and this adds to costs.

It is an aim of the present invention to obviate or reduce the above mentioned problems.

Accordingly, in one non-limiting embodiment of the present invention there is provided apparatus for generating electricity using water movement, which apparatus comprises:
(i) at least one electrical generator which is for generating the electricity and which comprises a housing, a rotor and a stator;
(ii) at least one control means for use in the maintenance of the apparatus,
   and the apparatus being such that:
(iii) the control means is configured to enable the removal of at least a defective part in the electrical generator;
(iv) the control means is configured to enable the reception of a replacement part for the defective part;
(v) the apparatus includes transport means for transporting the defective part around the apparatus such that the defective part is able to be removed from the apparatus, and for transporting the replacement part around the apparatus such that the replacement part is able to be installed in place of the defective part; and
(vi) the defective part and the replacement part are parts whereby the defective part is able to be removed by the control means, the replacement part is able to be installed by the control means, and the removal and replacement are able to be effected without the need for divers even although the apparatus in use is submerged at depth in the water.

The water that passes through the electrical generator in order to cause the electrical generator to generate the electricity may be an ocean current or it may alternatively be an ocean tidal flow. If an ocean current is being used, the apparatus is able to be submerged at a desired height off the ocean floor, and thereby be located in the ocean current and thereby best receive the ocean current. If a tidal flow is being used, the apparatus is able to be mounted on the ocean floor. The water may alternatively be in a river, estuary or other place. Generally, the apparatus may be mounted wherever appropriate in whatever water is desired. There will be no need to worry about the safety of divers operating in considerable depths of water and/or in dangerous conditions.

Advantageously, the apparatus may be such that the defective part is able to be removed and the replacement part is able to be installed whilst the apparatus is online and still generating electricity. This avoids interruption of the electrical supply, and it also avoids expensive downtime during which the apparatus is not generating electricity because it is being repaired.

The apparatus may be one in which the control means includes rotator means for rotating the replacement part of the electrical generator when it is received in the apparatus, whereby the replacement part is able to be lowered to the apparatus such that the thinnest cross sectional area of the replacement part is presented to the water movement and thereby generates a minimum drag through the water, and whereby the replacement part is able to be rotated to a correct orientation in the apparatus for the connection to the apparatus.

The rotator means may be a turntable which is vertically mounted so that it is parallel to the face of the electrical generator as installed in the apparatus. Such a turntable may be one known as a Lazy Susan. Other types of rotator means may be employed.

The apparatus may include raising and lowering means for raising the defective part from the apparatus to the water surface, and for lowering the replacement part to the apparatus from the water surface.

The raising and lowering means may include a cable for holding the defective part and the replacement part.

The raising and lowering means may include a camera for use in ascertaining the position of the defective part and the replacement part relative to the remainder of the apparatus.

The raising and lowering means may include latching means for latching to and releasing from the defective part and the replacement part. The latching means may be a remotely controlled claw. Other types of latching means may be employed.

The raising and lowering means may include a formation for enabling the defective part to be removed from the control means, and the replacement part to be connected to the control means. Any suitable formation may be employed.

The apparatus may be one in which the control means is configured to remove only the defective part of the electrical generator. In this case, the defective part may be, for example, a rotor and magnets. Other types of defective part may be removed.

Alternatively, the apparatus may be one in which the control means is configured to remove the entire electrical generator. In this case, for example, the entire electrical generator may comprise a rotor, magnets and a stator. Alternatively, the entire electrical generator may be, for example, a rotor, magnets, a stator and a housing. Other constructions for the entire electrical generator may be employed.

The housing of the electrical generator is preferably a hexagon in end view. Other shapes for the housing may be employed.

The control means may comprise a housing. The housing of the control means may typically be of the same shape in end view as the housing of the electrical generator. The housing of the control means may however be different in end view from the housing of the electrical generator if desired. Shapes other than hexagonal end shapes may be employed.

The apparatus may be one in which there is only one of the control means in the apparatus. Only one of the control means may be used when there is only one of the electrical generators, or where there is an array of the electrical generators but the array of generators is of a size which is able to be serviced by just one of the control means.

Alternatively, the apparatus may be one in which there is an array of the electrical generators, and in which there is more than one of the control means. More than one of the control means may be employed for large arrays of the electrical generators where it is easier to employ two or more of the control means rather than a single control means.

Any suitable and appropriate formations may be employed for enabling the defective part to the removed by the control means, and the replacement part to be installed by the control means. Thus, the defective part and the replacement part may be plug-in parts. The plug-in parts may be simple male and female joints. Alternatively, the male and female parts may include a twist lock formation. Alternatively, the male and female parts may be screw parts. The particular formations employed for the removal and replacement of the defective part and replacement part will usually also be employed for the formation on the raising and lowering means which enables the defective part to be removed from the control means, and the replacement part to be connected to the control means. Different formations may however be employed.

Embodiments of the invention will now be described solely by way of example and with reference to the accompanying drawings in which:

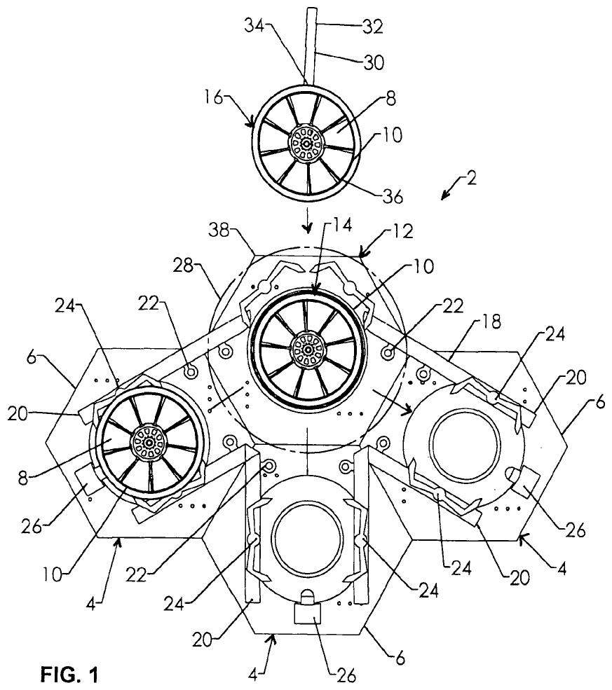

FIG. 1 is an end view of first apparatus of the present invention and illustrates the removal of a defective part and the installation of a replacement part;

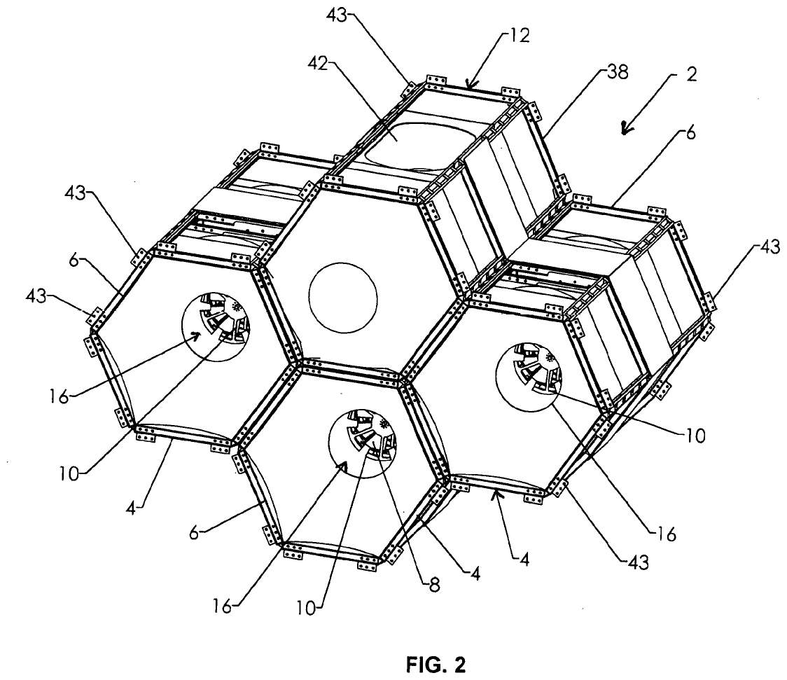

FIG. 2 is a perspective view from the front and above of the apparatus shown in FIG. 1;

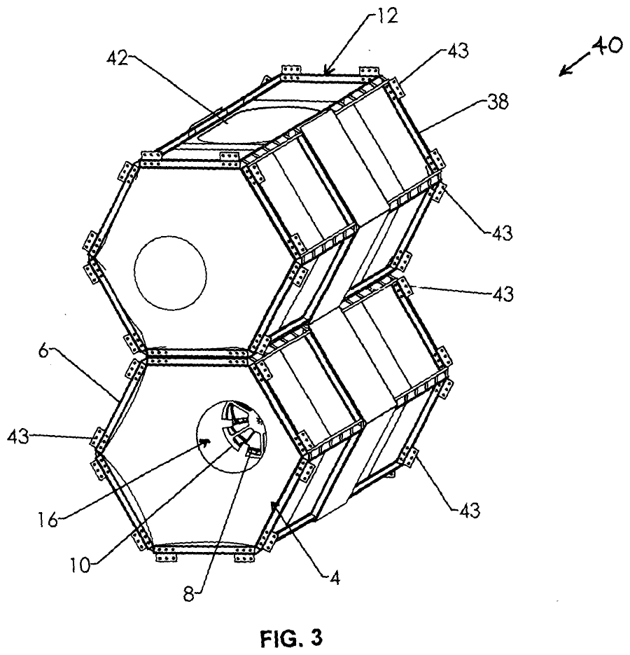

FIG. 3 is a perspective view from the front and above of second apparatus of the present invention;

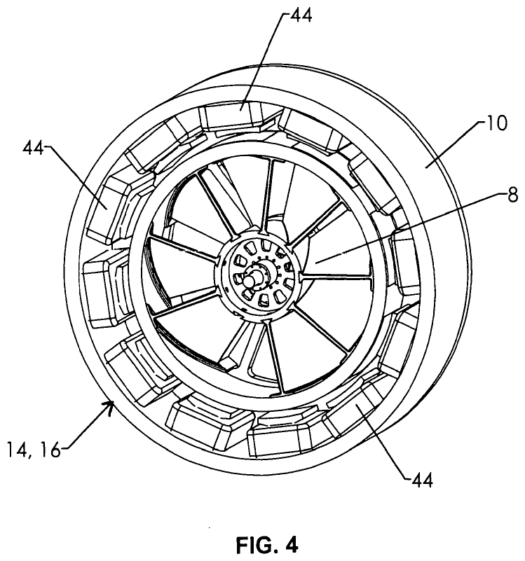

FIG. 4 is a perspective view from the front and one side of a defective part or a replacement part;

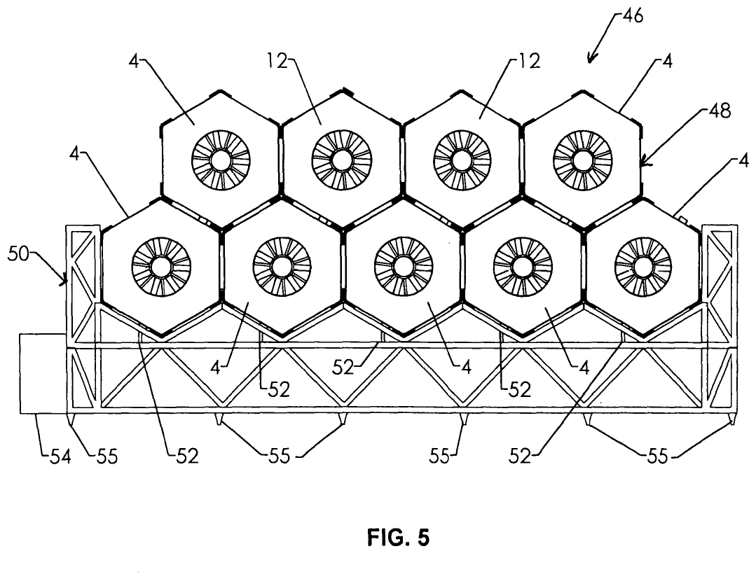

FIG. 5 is an end view of third apparatus of the present invention, with the apparatus being mounted on an installation cradle; and

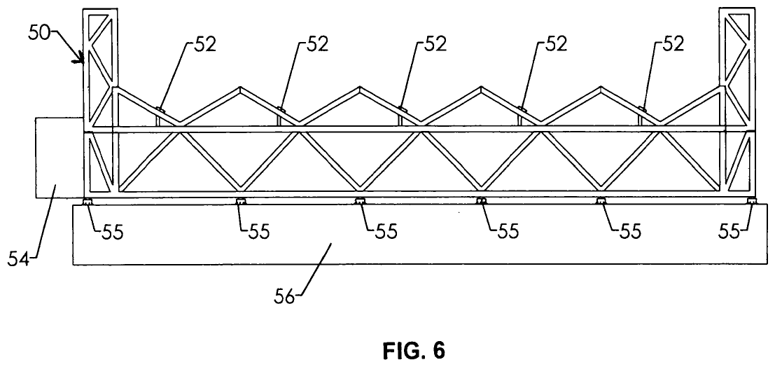

FIG. 6 shows the installation cradle of FIG. 5 and without the electrical generators and the control means.

Referring to FIGS. 1 and 2, there is shown apparatus 2 for generating electricity using ocean water movement. The apparatus 2 comprises three electrical generators 4. Each electrical generator 4 is for generating the electricity. Each electrical generator 4 comprises a housing 6, a rotor 8, and a stator 10.

The apparatus 2 further comprises control means 12. The control means 12 is for use in the maintenance of the apparatus 2.

The control means 12 is configured to enable the removal of at least one defective part 14 in each electrical generator 4. For ease of understanding, the defective part 14 is shown being positioned in the control means 12. The control means 12 is configured to enable the reception of a replacement part 16. For ease of understanding the replacement part 16 is shown being lowered into position into the control means 12.

The apparatus 2 includes transport means 18 for transporting the defective part 14 around the apparatus 2 such that the defective part 14 is able to be removed from the apparatus 2. The transport means 18 is also for transporting the replacement part 16 around the apparatus 2 such that the replacement part 16 is able to be installed in place of the defective part 14. As can be appreciated from FIG. 1, the transport means 18 is located partly in the control means 12 and partly in each one of the electrical generators 4.

The transport means 18 is shown as including a guide track 20, rollers 22, and locking devices 24 for locking and unlocking the defective part 14 and the replacement part 16.

The apparatus 2 is such that the defective part 14 and the replacement part 16 are parts whereby the defective part 14 is able to be removed by the control means 12, the replacement part 16 is able to be installed by the control means 12, and the removal and replacement are able to be effected without the need for divers even although the apparatus 2 in use is submerged at depth in the ocean water. More specifically, as shown in FIG. 1, the defective part 14 and the replacement part 16 are plug-in parts which plug into plug-in connections 26. The plug-in connections 26 enable the apparatus 2 to be maintained from the surface of the ocean. The apparatus 2 is constructed such that properly functioning electrical generators 4 are able to continue functioning. Thus the apparatus 2 is able to continue to provide electricity even during maintenance and/or repair. There is no need for the apparatus 2 to be stopped and taken off line during maintenance and/or repair, with consequent expensive downtime.

The control means 12 includes rotator means 28. The rotator means 28 is a vertical rotator means 28. The rotator means 28 is for rotating the replacement part 16 when it is received in the apparatus 2. The replacement part 16 is able to be lowered to the apparatus 2 such that the thinnest cross sectional area of the replacement part 16 is presented to the ocean water movement and thereby generates a minimum drag through the water. The replacement part 16 is able to be rotated by the rotator means 28 to a correct orientation in the apparatus 2 for the plug-in connection. The rotator means 28 is a turntable which is vertically mounted so that is parallel to the electrical generators 4 as installed in the apparatus 2.

The apparatus 2 includes raising and lowering means 30 for raising the defective part 14 from the apparatus 2 to the ocean surface, and for lowering the replacement part 16 to the apparatus 2 from the ocean surface. The raising and lowing means 30 includes a cable 32 for holding the defective part 14 and the replacement part 16. The raising and lowering means 30 also includes a camera 34 for use in ascertaining the position of the defective part 14 and the replacement part 16 relative to the remainder of the apparatus 2.

The raising and lowering means 30 may also include latching means (not shown) for latching to and releasing the defective part 14 and the replacement part 16. The latching means may be a remote controlled claw.

The raising and lowering means 30 may also include a formation (not shown) for enabling the defective part 14 to be removed from the control means 12, and the replacement part 14 to be connected to the control means. The formation may be, for example, a plug-in formation.

As shown in FIG. 1, the control means 12 is removing only the defective part 14 of the electrical generator. This defective part 14 is shown as a rotor 36 having magnets (not shown). In an alternative embodiment of the invention, the control means 12 may be configured to remove the entire electrical generator 4. The entire electrical generator 4 may be, for example, a combination of the rotor, magnets and stator, or a combination of the rotor, magnets, stator and the housing 6.

As shown in FIGS. 1 and 2, the housing 6 of each electrical generator 4 is a hexagon in end view. The control means 12 comprises a housing 38. The housing 38 is of the same shape as the housings 6. There is one of the control means 12 for servicing three of the electrical generators 4.

Referring now to FIG. 3, there is shown apparatus 40 which is like the apparatus 2 except that there is only one of the electrical generators 4. Similar parts as in FIGS. 1 and 2 have been given the same reference numerals for ease of comparison and understanding.

FIG. 3 shows how the housing 38 of the control means 12 is provided with an opening 42 through which the defective part 14 and the replacement part 16 are passed. FIG. 3 also shows how the housing 6 in FIGS. 1 and 3, the housing 6 in FIG. 3, and the housing 38 in FIGS. 1, 2 and 3 are provided with lugs 43 for enabling the housing 6, 38 to be connected together, for example by nuts and bolts.

FIG. 4 shows an example of a defective part 14 or a replacement part 16. The part 14, 16 is shown as comprising the rotor 8, the stator 10, and magnets 44.

FIGS. 5 and 6 show apparatus 46 of the present invention. The apparatus 46 comprises seven of the electrical generators 4, and two of the control means 12. The left hand control means 12 services the four electrical generators 4 to the left of FIG. 5, whilst the right hand control means 12 services the three electrical generators to the right of FIG. 5. The electrical generators 4 and the control means 12 form an array 48 which is mounted on a support cradle 50. The support cradle 50 is of tubular construction as best shown in FIG. 6. The support cradle 50 has plug-in electrical connector means 52 for enabling the lowermost electrical generators 4 to be connected to a bus bar or other main cable for providing the electricity to electricity-collecting apparatus 54. The electricity collecting apparatus 54 is able to adjust the electricity as it arrives and then send it to the surface, via a cable (not shown). The support cradle 50 is also shown with feet 55 for enabling the support cradle 50 to be mounted on a support surface such for example as the ocean bed (not shown) or on a support base 56 as shown in FIG. 6.

The apparatus 2, 40, 46 is easily able to be operated. There is no need for divers to dive to considerable depths in oceans in order to try and effect repairs to the apparatus. The apparatus 2, 40, 46 is able to be maintained, serviced and repaired from the ocean surface.

It is to be appreciated that the embodiments of the invention described above with reference to the accompanying drawings have been given by way of example only and that modifications may be effected. Thus, the apparatus may be used in water other than ocean water, for example river water. Connections other than the plug-in connections 26 may be employed. The connections may be for more than one service, for example for electricity and also hydraulics. The control means 12 may be of other designs, and the control means 12 may include different parts to those shown. Individual components shown in the drawings are not limited to use in their drawings and they may be used in other drawings and in all aspects of the invention.

1. Apparatus for generating electricity using water movement, which apparatus comprises:
(i) at least one electrical generator which is for generating the electricity and which comprises a housing, a rotor and a stator;
(ii) at least one control means for use in the maintenance of the apparatus,
and the apparatus being such that:
(iii) the control means is configured to enable the removal of at least a defective part in the electrical generator;
(iv) the control means is configured to enable the reception of a replacement part for the defective part;
(v) the apparatus includes transport means for transporting the defective part around the apparatus such that the defective part is able to be removed from the apparatus, and for transporting the replacement part around the apparatus such that the replacement part is able to be installed in place of the defective part; and
(vi) the defective part and the replacement part are parts whereby the defective part is able to be removed by the control means, the replacement part is able to be installed by the control means, and the removal and replacement are able to be effected without the need for divers even although the apparatus in use is submerged at depth in the water.

2. Apparatus according to claim 1 in which the control means includes rotator means for rotating the replacement part of the electrical generator when it is received in the apparatus, whereby the replacement part is able to be lowered to the apparatus such that the thinnest cross sectional area of the replacement part is presented to the water movement and thereby generates a minimum drag through the water, and whereby the replacement part is able to be rotated to a correct orientation in the apparatus for the connection to the apparatus.

3. Apparatus according to claim 2 in which the rotator means is a turntable which is vertically mounted so that it is parallel to the face of the electrical generator as installed in the apparatus.

4. Apparatus according to claim 1 and including raising and lowering means for raising the defective part from the apparatus to the water surface, and for lowering the replacement part to the apparatus from the water surface.

5. Apparatus according to claim 4 in which the raising and lowering means includes a cable for holding the defective part and the replacement part.

6. Apparatus according to claim 4 in which the raising and lowering means include a camera for use in ascertaining the position of the defective part and the replacement part relative to the remainder of the apparatus.

7. Apparatus according to claim 4 in which the raising and lowering means includes latching means for latching to and releasing from the defective part and the replacement part.

8. Apparatus according to claim 7 in which the latching means is a remotely controlled claw.

9. Apparatus according to claim 4 in which the raising and lowering means includes a formation for enabling the defective part to be removed from the control means, and the replacement part to be connected to the control means

10. Apparatus according to claim 1 in which the control means is configured to remove only the defective part of the electrical generator.

11. Apparatus according to claim 1 in which the control means is configured to remove the entire electrical generator.

12. Apparatus according to claim 1 in which the housing of the electrical generator is a hexagon in end view.

13. Apparatus according to claim 1 in which the control means comprises a housing.

14. Apparatus according to claim 13 in which the housing of the control means is of the same shape in end view as the housing of the electrical generator.

15. Apparatus according to claim 1 in which there is only one of the control means in the apparatus.

16. Apparatus according to claim 1 in which there is an array of the electrical generators, and in which there is more than one of the control means.

17. Apparatus according to claim 1 in which the defective part and the replacement part are plug-in parts.
